(19) United States
(12) Patent Application Publication
(10) Pub. No.: US 2013/0043966 A1
(43) Pub. Date: Feb. 21, 2013

(54) TRANSFORMER TAP PROJECTION AND COVER

(71) Applicants: Bandeep Singh, Wytheville, VA (US); Thomas A. Hartmann, Wytheville, VA (US); Samuel S. Outten, Wytheville, VA (US); Joel A. Kern, Wytheville, VA (US)

(72) Inventors: Bandeep Singh, Wytheville, VA (US); Thomas A. Hartmann, Wytheville, VA (US); Samuel S. Outten, Wytheville, VA (US); Joel A. Kern, Wytheville, VA (US)

(73) Assignee: ABB Technology AG, Zurich (CH)

(21) Appl. No.: 13/209,842

(22) Filed: Aug. 15, 2011

(51) Int. Cl. H01F 27/29

(52) U.S. Cl. 336/192

(57) ABSTRACT

Tap covers and projections for an electrical device are provided. The tap projections have bosses or taps raised from a surface of the tap projection and encapsulated with a resin except for an outer surface of the bosses or taps. The tap projections may have a channel or recess between individual bosses or taps to prevent degradation of the insulation between the respective adjacent bosses or taps. When a tap cover is provided, it is pushed on or bolted to the tap projection. The tap cover may be provided for an individual tap or an entire tap projection and may be formed of a resin or an elastomeric material. The tap cover has a first generally planar surface and a second generally annular surface having a circumferentially-extending groove on an inside surface. The circumferentially-extending groove is located slightly beneath the second generally annular surface. The groove of the tap cover is designed to fully engage with a raised lip of a tap projection or individual tap of a transformer. Another embodiment of the tap cover has openings to receive epoxy-headed bolts that are used to connect the tap cover to the tap projection through the tap connectors.

### FIELD OF INVENTION

The present invention is directed to tap projections and tap covers for use in outdoor and indoor electrical applications.

### BACKGROUND

Taps are connection points along the windings of an electrical device, such as a transformer, that may be used to control the turns ratio of the primary winding to the secondary winding and as a result, the desired voltage, current or phase adjustments may be achieved at the output of the transformer. The taps are typically contained in tap projections that extend from an outer surface of a coil winding. In general, taps must be enclosed whether the transformer is located inside a building or outdoors to protect the taps from dust, dirt, and moisture. When a transformer is located outdoors, the tap projection is exposed to pollution, pests, and the elements such as rain, snow, wind, and ultraviolet rays. Over time, these factors can cause the deterioration of the insulating materials in and around the tap projection.

Metal tap covers are known in the art, but require bolting and fastening of the metal cover to the transformer. Metal tap covers also interfere with the electrostatic field due to their conductive properties. There is a need in the art for a protective tap cover that is simple to install and remove, does not require bolted connections and is formed from a non-conductive material. There is also a need in the art for a tap projection for outdoor electrical devices that are exposed to extreme environments.

### SUMMARY

A winding assembly for an electrical device comprises a winding having a plurality of turns of an electrical conductor, a polymer encasement encapsulating the winding, a polymer tap protrusion extending outwardly from the encasement and a plurality of taps connected to the turns of the electrical conductor. The polymer tap protrusion has an arcuate side surface and a connection surface. Each tap of the plurality of taps at least partially extends through a corresponding tap protrusion which further comprises a tap connector. The tap connectors protrude from the connection surface of the tap protrusion.

### BRIEF DESCRIPTION OF THE DRAWINGS

In the accompanying drawings, structural embodiments are illustrated that, together with the detailed description provided below, describe exemplary embodiments of a tap projection and protective cover for transformer taps. One of ordinary skill in the art will appreciate that a component may be designed as multiple components or that multiple components may be designed as a single component.

Further, in the accompanying drawings and description that follow, like parts are indicated throughout the drawings and written description with the same reference numerals, respectively. The figures are not drawn to scale and the proportions of certain parts have been exaggerated for convenience of illustration.

FIG. 1 is a front elevational view of a transformer having tap covers and tap projections embodied in accordance with the present invention;

FIG. 2 is an isometric view of a first embodiment of a tap projection having bosses that extend from a top surface of a tap projection;

FIG. 3 is an isometric view of a second embodiment of a tap projection having a channel between a first group of taps and a second group of taps and a tap bar connecting tap E and tap G;

FIG. 4 is an isometric view of a third embodiment of a tap projection having a channel between a first group of taps and a second group of taps and recesses between individual taps;

FIG. 5 is an isometric view of a fourth embodiment of a tap projection;

FIG. 6 is an isometric view of a fifth embodiment of a tap projection;

FIG. 7 is an isometric view of a transformer tap projection without a tap cover;

FIG. 8 is an isometric view of the transformer tap projection of FIG. 7 shown partially in phantom and a first embodiment of a tap cover embodied in accordance with the present invention;

FIG. 9 is a partial side view of the tap cover of FIG. 8 showing a portion of the tap projection in phantom.

FIG. 10 is an isometric view of a tap projection having a uniform circumference and without a tap cover;

FIG. 11 is an isometric view of the tap projection of FIG. 10 having a second embodiment of the tap cover enclosing individual taps;

FIG. 12 is an isometric view of the tap projection of FIG. 11 having all taps enclosed by individual tap covers;

FIG. 13 is an isometric view of a third embodiment of a tap cover embodied in accordance with the present invention having epoxy-headed bolts that extend through openings in the tap cover; and

FIG. 14 is a side view of FIG. 13 showing the tap cover in engagement with the tap projection and the gap between the tap cover and a main body of the tap projection.

### DETAILED DESCRIPTION

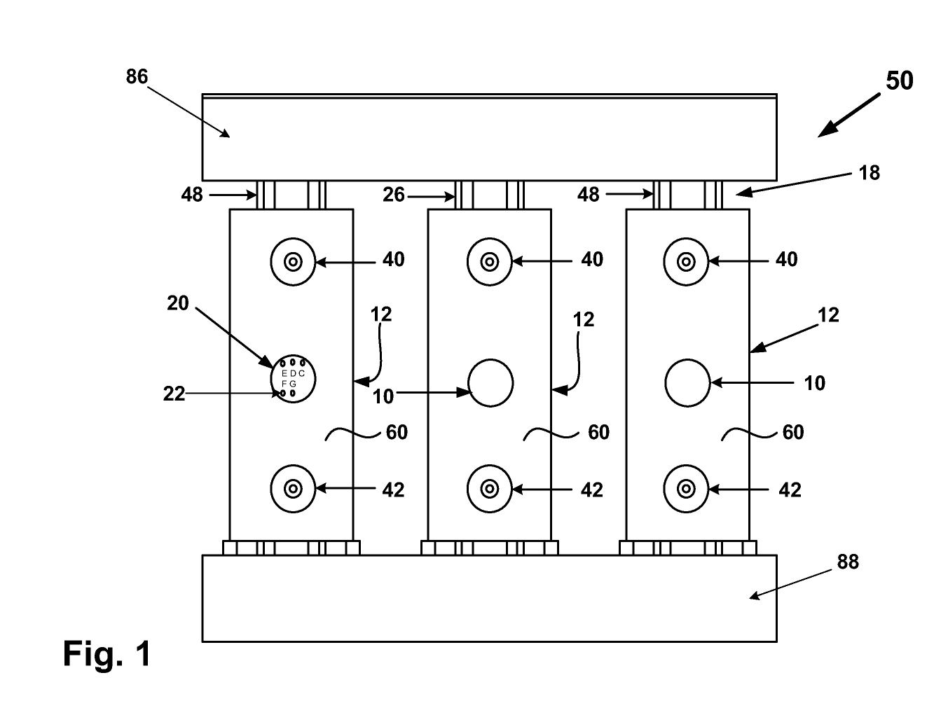

Referring to FIG. 1, an exemplary electrical device, a three-phase transformer 50, is shown. The transformer 50 is shown having tap covers 10 and tap projections 20. The transformer 50 has a core 18 comprised of two outer core legs 48, an inner core leg 26 and two yokes (not shown), although it should be appreciated that the transformer 50 may be embodied as a single phase transformer having two core legs 26, 48 and a winding assembly 12. The core 18 is held together by a set of upper clamps 86 and a set of lower clamps 88. The transformer 50 has three winding assemblies 12, each of which are mounted to an associated one of the inner and outer core legs, 26, 48. The winding assemblies 12 are comprised of a high-voltage winding and a low-voltage winding. Each winding assembly 12 is encapsulated in an encasement 60 formed from a resin.

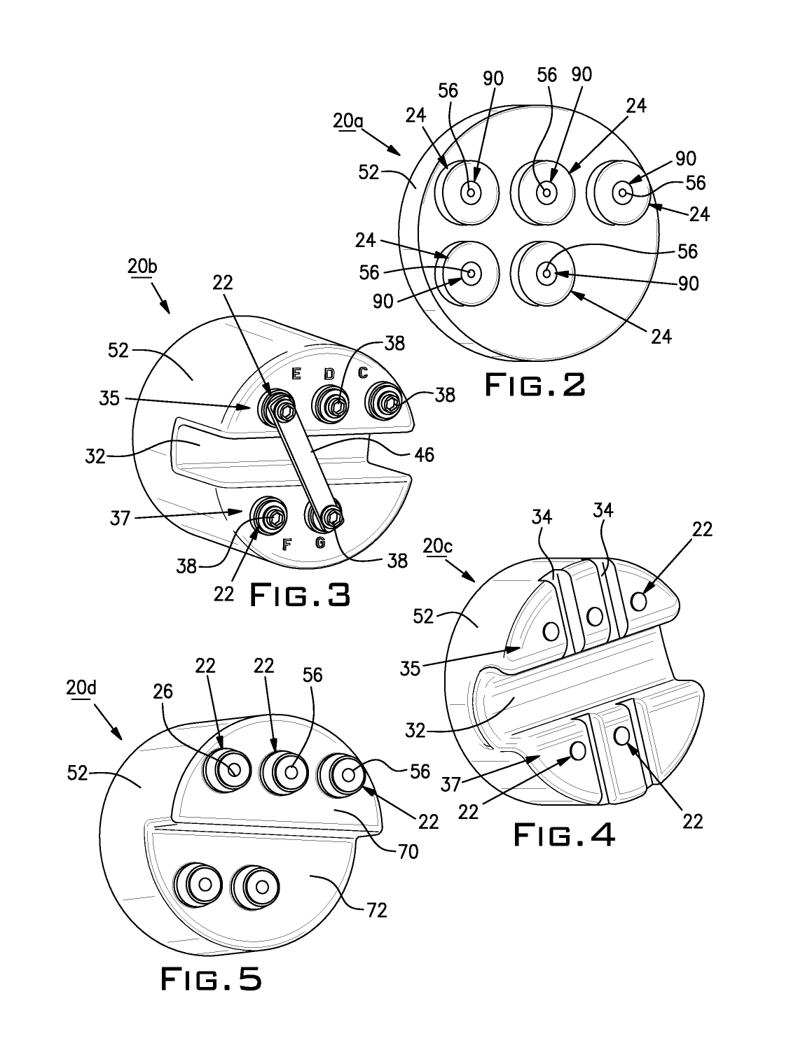

A first high-voltage bushing 40 is located at the beginning of the high-voltage winding and represents “tap A” in conventional nomenclature and a second high-voltage bushing 42 is attached at the end of the high-voltage winding and represents “tap B” in conventional nomenclature. The other taps 22 (“C,” “D,” “E,” “F” and “G”) are housed in a tap projection 20. The bushings 40, 42 and the tap projections 20 extend outwardly from a main body of the encasement 60. The tap projection 20 may be configured for indoor or outdoor (not in a building) applications. For example, the tap projection 20 may utilize a tap cover 10 to cover and protect the entire tap projection 20 or an individual tap 22 in an indoor application. The tap cover 10 is depicted in several embodiments in FIGS. 1, 8, 9, 11, 12, 13, and 14. Alternatively, the tap projection 20 may be configured for an outdoor environment, as depicted in FIGS. 2-6. It should be understood that although the tap projection 20 and the tap cover 10 are described in the below embodiments as outdoor or indoor embodiments, they may be used interchangeably. More particularly, the outdoor embodiments of the tap projection 20 may be utilized in an indoor environment.

It should be understood that the transformer 50 may be embodied as a poly-phase or a single-phase transformer 50 and may utilize the tap cover 10 or tap projection 20 in conjunction with a low-voltage or a high-voltage coil winding. Tap A may serve as the start terminal of the transformer 50 and tap B may serve as the finish terminal of the transformer 50 or any other tap connection that is near the beginning, end or middle of a high-voltage or low-voltage coil winding.

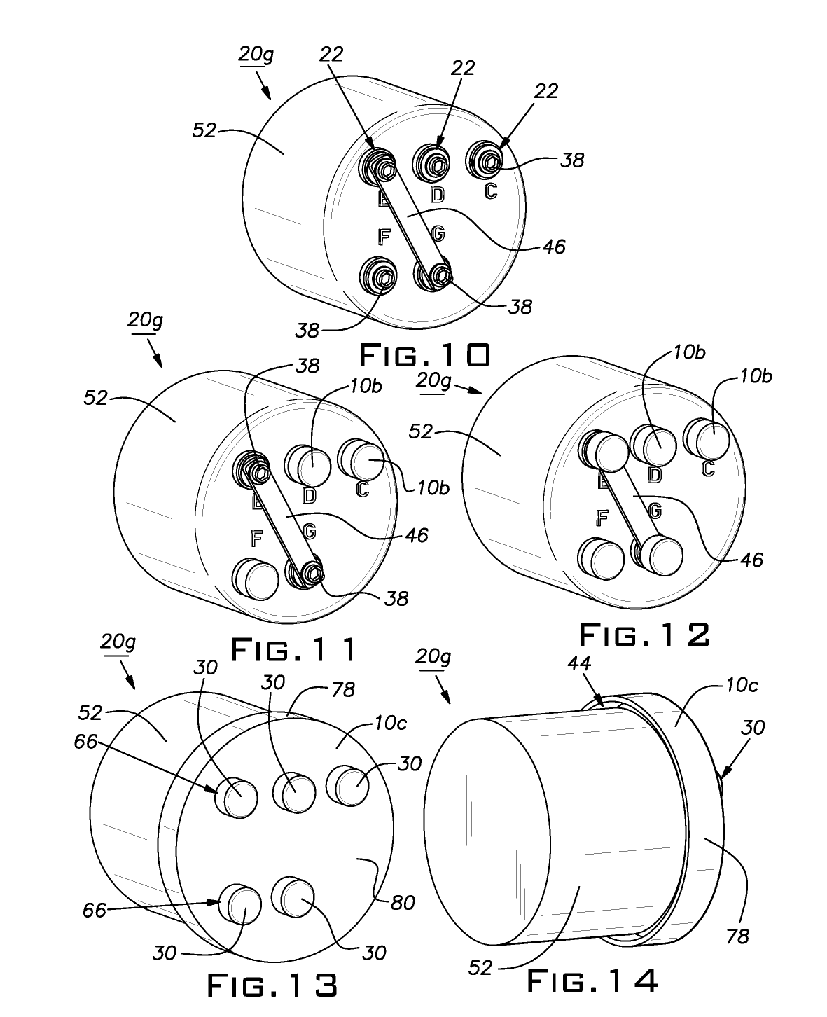

Referring additionally to FIGS. 7 and 10, high-voltage tap projections 20f, 20g are shown having individual taps 22 labeled C, D, E, F and G that represent positions along a coil winding where connections are made to achieve a desired turns ratio, and as a result, a specific output voltage. Each tap 22 includes a cable having a first end attached to a turn on the coil winding and a second end connected to a tap connector 56 in a tap projection 20. The tap connector 56 is formed of brass or another material having similar conductive properties.

The tap projection 20g shown in FIG. 10 allows for five different tap connections, E to F, F to D, E to G, D to G, or G to C wherein the output rating for the transformer 50 is achieved at a nominal connection of E to G. The other possible connections may result in about a 2.5 percent or about a 5 percent or about a 7.5 percent increase or decrease in output voltage in relation to the output voltage of the nominal connection. It should be appreciated that other tap configurations and output voltages may be utilized based on specific requirements.

Referring now to FIG. 2, a first outdoor embodiment of the tap projection 20a is shown. The tap projection 20a is formed from cycloaliphatic epoxy resin. The tap projection 20a has a main body 52 that is generally arcuate in circumference and a top surface that is generally planar. Bosses 90, extend from the top surface of the main body 52. The bosses 90 each have a central area through which a tap connector 56 extends. The tap connector 56 is utilized for making a connection with another selected tap connector 56. The top surface of the tap connector 56 extends about 1.5 mm outward from an outermost surface of the boss 90.

The bosses 90 of the tap projection 20a in conjunction with the properties of the cycloaliphatic epoxy resin, more particularly a hydrophopic cycloaliphatic epoxy resin, allow the tap projection 20a to shed and repel water when the transformer 50 is located in an outdoor environment. In one embodiment, the boss 90 has a height of about 25 mm to about 30 mm as measured from the top surface of the main body 52.

In that same embodiment, the diameter of the tap projection 20a is about 200 mm as measured across the first planar surface and the diameter of each of the bosses 90 is about 45 mm to about 50 mm, as measured across a top surface of each boss 90. In that same embodiment, the distance between adjacent tap connectors 56 of the at least two bosses 90 is about 50 mm to about 60 mm which includes a raised portion 24 of the at least two bosses 90.

The shortest path between two conductive parts, as measured along the surface of the insulation separating the two conductive parts, is often referred to as creepage distance. A creepage distance is often necessary between conductive parts that have a certain voltage differential between them. An adequate creepage distance protects against the erosion of insulation that may eventually lead to a partially conducting path of localized deterioration on the surface of the insulation. This is known as tracking. In FIG. 2, the tap connectors 56 have a creepage distance of about 50 mm to about 60 mm with respect to one another. The range of voltage differential between the tap connectors is about 2 kV to about 8 kV between adjacent tap connectors 56.

The creepage distance of about 50 mm to about 60 mm between each tap connector 56 of FIG. 2 is achieved over a two-dimensional surface area, owing to the raised portions 24 of the bosses 90. Allowing for a creepage distance over a two-dimensional surface may result in a smaller footprint for the tap projection 20a than a creepage distance over a planar surface.

Each encasement 60, including the tap projection 20 which extends therefrom, may be formed from a single insulating resin, which is an epoxy resin. In one embodiment, the resin is a cycloaliphatic epoxy resin, still more particularly a hydrophobic cycloaliphatic epoxy resin composition. Such an epoxy resin composition may comprise a cycloaliphatic epoxy resin, a curing agent, an accelerator and filler, such as silanised quartz powder, fused silica powder, or silanised fused silica powder. In one embodiment, the epoxy resin composition comprises from about 50-70% filler. The curing agent may be an anhydride, such as a linear aliphatic polymeric anhydride, or a cyclic carboxylic anhydride. The accelerator may be an amine, an acidic catalyst (such as stannous octoate), an imidazole, or a quaternary ammonium hydroxide or halide.

The encasement 60, including the tap projection 20, may be formed from the resin composition in an automatic pressure gelation (APG) process. In accordance with APG process, the resin composition (in liquid form) is degassed and preheated to a temperature above 40° C., while under vacuum. The winding assembly 12 is placed in a cavity of a mold heated to an elevated curing temperature of the resin. The degassed and preheated resin composition is then introduced under slight pressure into the cavity of a mold. Inside the cavity, the resin composition quickly starts to gel. The resin composition in the cavity, however, remains in contact with pressurized resin being introduced from outside the cavity. In this manner, the shrinkage of the gelled resin composition in the cavity is compensated for by subsequent further addition of degassed and preheated resin composition entering the cavity under pressure. After the resin composition cures to a solid, the solid encasement 60 including the winding assembly 12 and tap projection 20 is removed from the mold cavity. The encasement 60 is then allowed to fully cure.

Additionally, in lieu of being formed pursuant to an APG process, the encasement 60, including the tap projection 20, may be formed using an open casting process or a vacuum casting process. In an open casting process, the resin composition is simply poured into an open mold containing the winding assembly 12 and then heated to the elevated curing temperature of the resin. In vacuum casting, the winding assembly 12 is disposed in a mold enclosed in a vacuum chamber or casing. The resin composition is mixed under vacuum and introduced into the mold in the vacuum chamber, which is also under vacuum. The mold is heated to the elevated curing temperature of the resin. After the resin composition is dispensed into the mold, the pressure in the vacuum chamber is raised to atmospheric pressure for curing the part in the mold. Post curing can be performed after de-molding the part.

Referring now to FIG. 3, a second outdoor embodiment of the tap projection 20b is depicted. The tap projection 20b has a generally cylindrical main body 52 that accommodates a first group 35 of taps 22 and a second group 37 of taps 22. It should be appreciated that although five taps 22 are shown in the drawings, the number of taps 22 may range from two taps to eight taps depending on the application.

The second outdoor embodiment of the tap projection 20b has a channel 32 which allows for a creepage distance of about 120 mm as between the individual taps 22. The voltage differential between the individual taps 22 may range from about 2 kV to about 8 kV. The creepage distance, as measured from tap E to tap G in FIG. 3, includes the width of a flat portion of the channel and the width of opposing side portions of the channel 32. The creepage distance may be slightly larger or smaller depending on the configuration of the taps 22.

A manual connection between tap E and tap G using a tap bar 46 is depicted in FIG. 3. The tap bar 46 is a generally rectangular, flat bar or cable made of an electrically conductive material such as copper, aluminum or brass. The tap bar 46 has first and second openings on opposing ends. The tap bar 46 is positioned with the first opening placed over the center of a tap connector 56 of the first selected tap 22 and the second opening placed over the center of a tap connector 56 of the second selected tap 22, so that the tap bar 46 first and second ends are flat against the tap connector 56 of the first and second selected taps 22. The tap bar 46 openings are large enough to accommodate the body of a bolt 38 that threadably engages with a tap connector 56.

Referring now to FIG. 4, a third outdoor embodiment of the tap projection 20c is shown. The tap projection 20c of FIG. 4 is the same as FIG. 3, except that the channel 32 is arcuate in cross-section and has opposing arcuate end portions located at the circumference of the main body 52 and a recess 34 is disposed between each of the taps 22. The recess has a first end that is disposed near an outer edge portion of the channel 32 and a second end that is disposed near an outer surface portion of the tap projection 20c. The channel 32 of the third embodiment of the tap projection 20c has a creepage distance of about 140 mm between the first and second groups 35, 37 of taps 22. The tap projection 20c of FIG. 4 is particularly suitable in an outdoor application that requires the tap projection 20c to withstand heavy rain and/or a relatively high air pollution level.

Referring now to FIG. 5, a fourth outdoor embodiment of the tap projection 20d is depicted. The tap projection 20d is the same as FIGS. 3 and 4 except that the creepage distance is achieved by elevating a first portion 70 of the tap projection 20d about 50 mm to about 60 mm from a top surface of a second portion 72 of the tap projection 20d. The first and second portions 70, 72 are generally semi-circular in shape. In the fourth embodiment, the taps 22 are also slightly raised from a top surface of the first and second portions 70, 72 of the tap projection 20d.

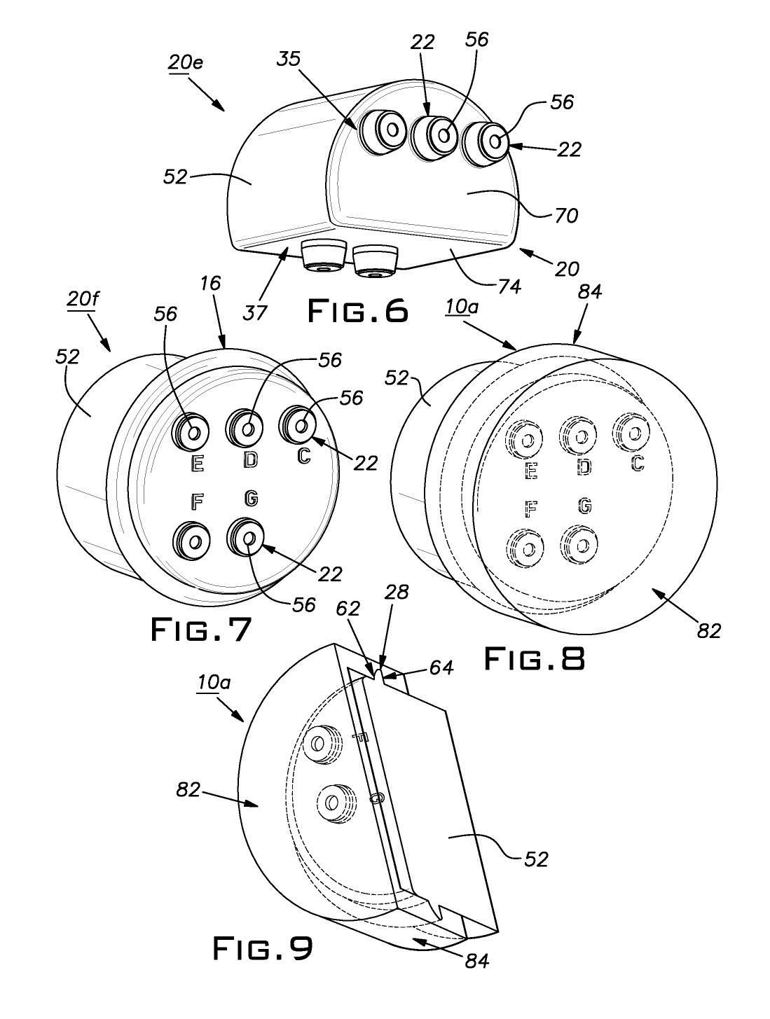

Referring now to FIG. 6, a fifth embodiment of the outdoor tap projection 20e is depicted and includes a partially cylindrical body having an end wall 70 with a first group 35 of taps 22 disposed thereon, an arcuate side wall 52, and a planar wall 74 joined between opposing ends of the arcuate side wall 52. A second group 37 of taps 22 is located on the planar wall 74 of the tap projection 20e.

When a tap connection is made between a tap 22 of the first group 35 of taps 22 and a tap 22 of the second group 37 of taps 22 in the tap projections 20d, 20e of FIGS. 5 and 6, the tap bar 46 must be bent. The tap bar 46 is bent at a point adjacent to, but not touching, the edge joining the end wall 70 and the planar wall 74.

The tap projections 20a, 20b, 20c, 20d, 20e of FIGS. 2-6 have relatively high creepage distances between individual taps 22 over voltage differentials ranging from about 2 kV to about 8 kV and are designed to withstand relatively high pollution, heavy rainfall, and other factors in outdoor environments.

With reference now to FIG. 7, a tap projection 20f that may utilize a tap cover 10 in an indoor application is shown. The tap projection 20f has a generally arcuate main body 52 and a circumferentially-extending lip 16 disposed on the main body 52.

Referring now to FIGS. 8 and 9, a first embodiment of a tap cover 10a for an indoor electrical application is shown. The tap cover 10a is designed to removeably engage with the tap projection 20f of FIG. 7. The tap cover 10a is installed by manually pushing the tap cover 10a onto the tap projection 20f. The tap cover 10a is self-sealing and may be removed without the use of a tool. The tap cover 10a has a generally planar end wall 82 joined to a generally cylindrical side wall 84. A circumferentially-extending groove 28 is formed in an interior surface of the side wall 84.

The end wall 82 has a diameter of about 126 mm. The side wall 84 has a diameter of about 129 mm to about 130 mm. The difference in diameter between the end wall 82 and the side wall 84 allows the tap cover 10a seal against the circumferentially-extending lip 16 of the tap projection 20. The difference in diameter is represented as an increase in diameter of about 3 mm along the length of about 20 mm, as measured from a top edge portion of the end wall 82 to a bottom edge portion of the side wall 84.

The groove 28 has a flat first portion 64 and an arcuate second portion 62 to accommodate the circumferentially-extending lip 16 when the tap cover 10a is removeably engaged with the tap projection 20f. In one embodiment, the first portion has a width of about 5 mm and the second portion 62 has a radius of about 58 mm (if the second portion 62 was formed as a complete circle). The end wall 84 is about 5 to about 10 mm in thickness, as measured from an inside surface of the end wall 84 to an outside surface of the end wall 84.

A second embodiment of a tap cover 10b for an indoor electrical application is depicted in FIGS. 11 and 12. The tap cover 10b encloses an individual tap 22. The individual tap cover 10b may be installed or removed in the same manner as the tap cover 10a for the tap projection 20f. The tap connectors 56 are raised from about 5 mm to about 50 mm from the surface of the tap projection 20g. The individual tap cover 10b is adapted to removeably engage with an associated one of the tap connectors 56 through a circumferentially-extending groove 28 disposed in an inside surface of the tap cover 10b which receives a circumferentially-extending raised portion formed on an outer surface of the tap connector 56.

The tap covers 10a, 10b of FIGS. 8, 9, 11, and 12 may be formed of an epoxy resin such as cycloaliphatic epoxy, hydrophobic cycloaliphatic epoxy, siliconized hydrophobic cycloaliphatic epoxy, or indoor bisphenol A-based epoxies utilizing acid or anhydride curing agents. The tap cover 10a, 10b may be formed from an APG, vacuum casting or open casting process as previously described and is formed separately from the encasement 60. Alternatively, the tap cover 10a, 10b may be formed of silicone rubber, more particularly, a UV-curable silicone rubber, high temperature vulcanized silicone rubber, or room temperature vulcanized silicone rubber.

Referring now to FIG. 13, a third embodiment of a tap cover 10c for an indoor electrical application is shown. The tap cover 10c is bolted to a tap projection 20g through the tap connectors 56. The tap cover 10c is designed to engage with a tap projection 20g having a uniform circumference as depicted in FIG. 10. The tap cover 10 is formed from a resin, more particularly a cycloaliphatic epoxy resin or a hydrophobic cycloaliphatic epoxy resin and has openings 66 in an end wall 80 through which the tap connectors 56 may at least partially extend. In this arrangement, the tap connectors 56 are slightly recessed within the openings 66 of the tap cover 10c.

The tap cover 10c is connected to the tap projection 20g through the tap connectors 56 by placing the tap cover openings 66 over the tap connectors 56 so that the tap connectors 56 extend at least partially through the tap cover 10c openings 66. The body of a bolt 30 is threadably engaged with an associated one of the tap connectors 56. The bolt 30 has a head formed of epoxy that keeps the tap cover 10c in place against the tap connectors 56 since the epoxy head is larger in circumference than the openings 66 of the tap cover 10c. In this configuration, the tap cover 10c sits about 5 mm from a top surface of the tap projection 20g as well as about 5 mm from an outer rim of the tap projection 20g.

In a typical installation, the tap cover 10c is first aligned over the taps 22 and then a tap bar 46 is secured between tap connectors 56 of a pair of desired taps 22. Bolts 30 are then threaded into the tap connectors 56 of the other taps 22, through the openings 66 in the tap cover 10c.

Referring now to FIG. 14, the tap cover of FIG. 13 is shown in a side view. When the tap cover 10 is attached to the tap projection 20g through the taps 22 using the bolts 30, a gap 44 remains between an inner surface of a side wall 78 of the tap cover 10c and an outer surface of the main body 52 of the tap projection 20g.

The tap projection 20 may be used in various tap configurations such as a dome configuration wherein the transformer 50 has a trapezoidal-shaped encasement 60 extending from an outer surface of the high-voltage windings. The tap projection 20 may be used with pad-mounted transformers, pole-mounted transformers, instrument transformers including current and voltage transformers, substation transformers, and other transformers and utility applications.

It should be appreciated that the taps 22 may extend directly from the surface of the high-voltage or low-voltage coil winding or encasement 60. In that same embodiment, the high- or low-voltage coil winding is typically encapsulated with a resin such as cycloaliphatic epoxy resin or another material that is the same as the resin that forms the tap projection 20. The taps 22 may extend perpendicularly or at various angles from the outer surface of the winding assembly 12 or encasement 60.

The tap cover 10 may be further secured to the tap projection 20 by fasteners to prevent tampering with the taps 22. The fasteners may be comprised of a metallic or non-metallic material suitable for the application. For instance, non-metallic materials suitable for the application are nylon, fiber reinforced plastic or another suitable material. The fasteners extend through openings in the top surface of the tap cover. The first end of the fastener has a head that holds the fastener in place when engaged with an opening of the tap cover and a second end that may extend into the epoxy or other material that encapsulates the coil windings. The fasteners may be comprised of metallic or non-metallic material suitable for the application. Fiber reinforced plastic is a composite material comprised of a polymer matrix reinforced with fibers. The fibers may be comprised of fiberglass, carbon, or an aromatic polyamid, and the polymer may be comprised of an epoxy, vinylester or polyester thermosetting plastic.

It should be appreciated that the tap projection 20 and the tap cover 10 may be utilized in an electrical device other than a transformer 50. It should also be appreciated that the tap cover 10 may provide added surface area to a tap projection 20 or configuration of taps 22 to provide additional creepage distance between adjacent conductors when the tap cover 10 is installed on the tap 22, tap connector 56 or tap projection 20.

While the present application illustrates various embodiments of a tap cover 10 and a tap projection 20, and while these embodiments have been described in some detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative embodiments, and illustrative examples shown and described. Accordingly, departures may be made from such details without departing from the spirit or scope of the applicant's general inventive concept.

What is claimed is:

1. A winding assembly for an electrical device, comprising:
a winding comprising a plurality of turns of an electrical conductor;
a polymer encasement encapsulating the winding;
a polymer tap protrusion extending outwardly from the encasement, the tap protrusion having an arcuate side surface and a connection surface; and
a plurality of taps connected to the turns of the electrical conductor, respectively, the taps at least partially extending through the tap protrusion and including connectors, respectively, the tap connectors protruding from the connection surface of the tap protrusion.

2. The winding assembly of claim 1 wherein a first group of tap connectors and a second group of tap connectors protrude from said connection surface, said first and second group of tap connectors being separated by a creepage distance.

3. The winding assembly of claim 2 wherein the creepage distance is disposed over a two-dimensional surface area.

4. The winding assembly of claim 1 wherein the encasement is comprised of a cycloaliphatic epoxy resin.

5. The winding assembly of claim 1 wherein the tap projection is comprised of a cycloaliphatic epoxy resin.

6. The winding assembly of claim 1 further comprising a channel disposed between a first group of the tap connectors and a second group of the tap connectors.

7. The winding assembly of claim 6 wherein the channel is generally arcuate in cross-section.

8. The winding assembly of claim 6 wherein the channel is comprised of a flat portion disposed between opposing side portions, said side portions extending outward from said flat portion.

9. The winding assembly of claim 6 further comprising a plurality of recesses, each having a first end and a second end, wherein in each of the first and second groups of tap connectors, a recess is disposed between adjacent individual tap connectors, and wherein the first end of each recess is disposed near one of the side portions of said channel and the second end of each recess is disposed near the side surface of said tap projection.

10. The winding assembly of claim 1 wherein a first portion of said tap projection is elevated in relation to a second portion of said tap projection, and wherein said connection surface has first and second portions located in the first and second portions of the tap projection, respectively, a first group of the tap connectors protruding from the first portion of the connection surface and a second group of the tap connectors protruding from the second portion of the connection surface.

11. The winding assembly of claim 1 wherein said tap projection is partially cylindrical, wherein the connection surface comprises a first portion joined at about a right angle to a second portion, the first portion of the connection surface extending between opposing ends of the side surface, and wherein a first group of the tap connectors protrude from the first portion of the connection surface and a second group of the tap connectors protrude from the second portion of the connection surface.

12. The winding assembly of claim 1, further comprising a tap cover disposed over one or more of the tap connectors.

13. The winding assembly of claim 12, wherein the tap cover is disposed over a plurality of tap connectors, and wherein the tap cover comprises a generally planar end wall connected to a generally cylindrical side wall, said side wall having a circumferentially-extending groove formed in an interior surface thereof, said groove adapted to receive a circumferentially-extending lip disposed on said tap projection.

14. The winding assembly of claim 13 wherein said groove has a first flat portion and a second arcuate portion.

15. The winding assembly of claim 12 wherein the cover comprises a cycloaliphatic epoxy resin.

16. The winding assembly of claim 12 wherein the cover comprises an elastomeric material.

17. The winding assembly of claim 16 wherein the elastomeric material is comprised of silicone rubber.

18. The winding assembly of claim 12 wherein a diameter of said end wall of the tap cover is smaller than a diameter of said side wall of the tap cover.

19. The winding assembly of claim 12, further comprising one or more other tap covers, wherein each tap cover is disposed over a single tap connector.

20. The winding assembly of claim 19, wherein each tap cover comprises a generally planar end wall connected to a generally cylindrical side wall, said side wall having a circumferentially-extending groove formed in an interior surface, said groove adapted to receive a circumferentially-extending raised portion formed on an outer surface of the tap connector associated with the tap cover.

21. The winding assembly of claim 19, wherein each tap cover has a threaded body that is threadably received in a threaded bore of the tap connector associated with the tap cover.

22. The winding assembly of claim 21, further comprising a cover plate disposed over the connection surface of the tap projection, the cover plate having a plurality of openings through which the tap connectors extend, respectively.

23. The winding assembly of claim 22 wherein each tap cover and the cover plate are formed from an epoxy resin.
